(19) United States
(12) Patent Application Publication
(10) Pub. No.: US 2026/0125296 A1
(43) Pub. Date: May 7, 2026

(54) DEVICE FOR PREPARING QUANTUM NANOCOMPONENT IONIC WATER

(71) Applicant: Jung O AN, Gwangju-si, Gyeonggi-do (KR)

(72) Inventors: Jung O AN, Gwangju-si (KR); Ji Ho JANG, Seoul (KR)

(73) Assignee: Jung O AN, Gwangju-si, Gyeonggi-do (KR)

(21) Appl. No.: 18/713,646

(22) PCT Filed: Jun. 3, 2022
(86) PCT No.: PCT/KR2022/007929

§ 371 Date: Jul. 2, 2025

(30) Foreign Application Priority Data
Jun. 3, 2021 (KR) 10-2021-0072077

(51) Int. Cl. C02F 1/461; B06B 1/04; B06B 1/06; C02F 1/34

(52) U.S. Cl. CPC C02F 1/4618; B06B 1/045; B06B 1/06; C02F 1/34; C02F 2201/002; C02F 2201/46125; C02F 2201/4615; C02F 2303/04

(57) ABSTRACT

A device for preparing quantum nanocomponent ionic water and, more specifically, to a device for preparing quantum nanocomponent ionic water, the device allowing: an area in which the frequency has dropped due to disease to be found on the basis of the intrinsic (standard) frequency in each area of a human body; and a normal frequency suitable for the diseased area to be transmitted to quantum nanocomponent ionizer units and ionic water to be generated.

### TECHNICAL FIELD

The present invention relates to a device for preparing quantum nanocomponent ionic water and, more specifically, to a device for preparing quantum nanocomponent ionic water, the device allowing: an area in which the frequency has dropped due to disease to be found on the basis of the intrinsic (standard) frequency in each area of a human body; and a normal frequency suitable for the diseased area to be transmitted to quantum nanocomponent ionizer units and ionic water to be generated.

### BACKGROUND ART

In general, an ionizer, which is a device for ionizing an object, may be used for the purpose of changing unionized water into ionic water, and the ionic water may be generated by electrolyzing raw water such as tap water, etc., in an unionized state, or by increasing surface tension of water and ionically activating molecular structures while the raw water moves to a path through which a permanent magnet forms a magnetic field at a right angle.

The advantage of using ionic water by users is that an acidic constitution may be improved to an alkaline constitution as the causes of various adult diseases such as high blood pressure, diabetes, heart disease, etc. in modern medicine have been revealed to be acidification of the constitution due to excessive intake of acidic foods.

In addition, when taking a shower or bathing with ionic water, water particles are ionized and become smaller than those of pre-ionized water, thereby increasing cleansing power and providing good effects for skin care, etc.

As a conventional invention for generating such ionic water, Korean Registered Patent No. 10-1576863 discloses a “device for generating ionic water.”

Meanwhile, it has been recently known that human psychology may be treated with the nature of sound:
a frequency for treating diseases and a sound therapy for strengthening body organs using the user's own voice. A frequency of specific pronunciations that a person may make is close to the frequency range of each body organ, and this principle may be used to treat diseases.

In fact, the medical community uses vibration therapy based on the hypothesis that all organs of the human body have their own frequencies, and it is already a common therapy in Europe or Japan.

Professor Jeong Seung-pil of the Department of Family Medicine at Yeungnam University has applied this therapy to patients'treatment, because the frequency of the human body may be measured to determine whether the patients are healthy, and the frequency of the organ with a problem deviates from the frequency range of their health status.

In other words, the intrinsic frequency of 58 Hz or more is normally measured in the 5216 areas of the body when the human body is subdivided, and the frequency is lower than the intrinsic frequency when there is a disease such as a tumor, etc., in the area of the body.

In addition, up to now, treatment is performed by analyzing organs, tissues, cells, and genes, and treatment is also performed by analyzing the same through shooting with CT, X-rays, etc., which are easily identified when a tumor size is large to some extent, thus making it difficult to heal when the disease has increased.

### DISCLOSURE

### Technical Problem

To solve the above problems, an object of the present invention is to provide a device for preparing quantum nanocomponent ionic water, the device allowing: an area in which the frequency has dropped due to disease to be found on the basis of the intrinsic (standard) frequency data in each area of a human body; and a normal frequency suitable for the diseased area to be transmitted to quantum nanocomponent ionizer units, so that it may be possible to treat various adult diseases such as diabetes, high blood pressure, obesity, etc., as well as diseases such as muscle pain, inflammation (arthritis), etc., according to an area of the body, or ameliorate various conditions by drinking ionic water containing gold, silver, platinum, silicon, and germanium components at a concentration of 3 to 8 ppm.

### Technical Solution

To achieve the objects described above, according to an embodiment of the present invention, a device for preparing quantum nanocomponent ionic water may include: a plurality of quantum nanocomponent ionizer units for generating ionic water by transmitting, to distilled water put into a container, in wave form, at least one from among an oscillating body, sound waves, and diode lights; a sensing unit having a detection sensor in contact with the palm so as to measure wave (frequency) in an area of the body of a subject to be measured; and a control unit which compares the measured frequency of the detection sensor with a standard frequency in each area so as to determine a diseased area, and which instructs the plurality of quantum nanocomponent ionizer units to provide each wave suitable for the diseased area.

In addition, the quantum nanocomponent ionizer unit may be formed by coupling an upper vibration transfer cover to a lower container filled with distilled water, in which
the lower container may be made of glass or a plastic material and may be formed with an accommodation part filled with distilled water containing organic germanium and a water-soluble silicon component, and
an ionization vibration transfer member made of a gold, silver, or platinum material may be mounted on a lower portion of the vibration transfer cover and thus immersed in distilled water filled in the lower container.

Furthermore, the vibration transfer cover may include a display unit for displaying a number for quantum nanocomponent ionizer units and subjects to be measured, a remaining time, and the number of uses, a switch for individually operating the quantum nanocomponent ionizer unit, and an operation lamp for indicating whether the quantum nanocomponent ionizer unit is operated, and
may be connected to a cable to provide power or to provide power and information.

Moreover, an accommodation space may be formed inside a main body of the device for preparing quantum nanocomponent ionic water, and a shelf support may be formed in multiple stages on both inner walls of the main body in which the accommodation space is formed, so that a shelf on which the plurality of quantum nanocomponent ionizer units are seated may be supported.

Besides, the device for preparing quantum nanocomponent ionic water may further include an input button unit consisting of a plurality of number or character buttons and ON and OFF buttons,
a display unit for displaying, under the control of the control unit, an abnormal part of the subject to be measured, and normal and current measured frequencies (numbers), which are detected through a detection sensor, a measurement date, a subject to be measured, and an unique ID of the quantum nanocomponent ionizer unit, and displaying the measured frequency of the most vulnerable part and the frequency of the current part of the subject to be measured in a graph form, and
an output unit for outputting, under the control of the control unit, a measurement date, a subject to be measured, and a unique ID of the quantum nanocomponent ionizer unit as a printed material.

In addition, the ionization vibration transfer member may be configured such that a coil is formed at one surface of an oscillating body made of a gold, silver, or platinum material in a thin plate-shape, and a permanent magnet inserted into the coil is formed at the opposite side of the coil and supported by a magnet support, which is fixedly attached to one surface of the oscillating body.

Furthermore, the ionization vibration transfer member may be formed by attaching piezoelectric ceramic to one surface of an oscillating body made of a gold, silver, or platinum material in a thin plate shape.

Moreover, the sensing unit may be configured such that (+) and (−) detection sensors containing silver (Ag) are vertically spaced apart from each other in a vertical portion of the main body made of a plastic material having a “E”shape.

Meanwhile, in another embodiment, the quantum nanocomponent ionizer unit may include a container in which distilled water is filled into an accommodation part having an open top, in which an ionization vibration transfer member made of a gold, silver, or platinum material is mounted on an upper portion of the container and thus immersed in the distilled water filled in the container, and the ionization vibration transfer member is electrically connected to a power supply terminal provided at an upper surface of a lower horizontal portion of the main body.

### Advantageous Effects

According to the technical solutions for the problems as described above, the device may allow: an area in which the frequency has dropped due to disease to be found on the basis of the intrinsic (standard) frequency data in each area of a human body; and a normal frequency suitable for the diseased area to be transmitted to quantum nanocomponent ionizer units, so that it may be possible to treat, for example, various adult diseases such as diabetes, high blood pressure, obesity, etc., as well as diseases such as muscle pain, inflammation (arthritis), etc., according to an area of the body, or ameliorate various conditions by drinking ionic water containing gold, silver, platinum, silicon, and germanium components at a concentration of 3 to 8 ppm.

### DESCRIPTION OF DRAWINGS

FIG. 1 is a perspective view showing a device for preparing quantum nanocomponent ionic water according to one embodiment of the present invention.

FIG. 2 is a perspective view showing a device for preparing quantum nanocomponent ionic water of FIG. 1 in an open state.

FIG. 3 is an exploded view showing a quantum nanocomponent ionizer unit shown in FIG. 1 according to one embodiment.

FIG. 4 is a perspective view showing a bottom surface of a vibration transfer cover shown in FIG. 3.

FIG. 5 is an exploded view showing a quantum nanocomponent ionizer unit shown in FIG. 1 according to another embodiment.

FIG. 6 is a perspective view showing a device for preparing quantum nanocomponent ionic water according to another embodiment of the present invention.

FIGS. 7A and 7B are perspective views showing an ionization vibration transfer member applied to a device for preparing quantum nanocomponent ionic water of the present invention.

FIG. 8 is a block view showing a configuration of a device for preparing quantum nanocomponent ionic water shown in FIG. 1.

### BEST MODE

The present invention may provide, in a desired aspect, a device for preparing quantum nanocomponent ionic water, the device including: a quantum nanocomponent ionizer unit for generating ionic water by transmitting, to distilled water put into a container, in wave form, at least one from among an oscillating body, sound waves, and diode lights; a sensing unit having a detection sensor in contact with a palm so as to measure wave (frequency) in an area of a body of a subject to be measured; and a control unit which compares the measured frequency of the detection sensor with a standard frequency in each area so as to determine a diseased area, and which instructs the quantum nanocomponent ionizer unit to provide each wave suitable for the diseased area.

### Mode for Invention

Hereinafter, configurations and operations for embodiments of the present invention will be described with reference to the accompanying drawings.

It should be noted that the same components in the drawings are denoted by the same reference numerals and symbols as possible even though they are displayed on different drawings.

In the following description of the present invention, a detailed description of known functions and configurations incorporated herein will be omitted when it may make the subject matter of the present invention unnecessarily unclear.

In addition, when a part is referred to include a certain component, it means that the part may further include other components rather than excluding the other components, unless otherwise particularly specified.

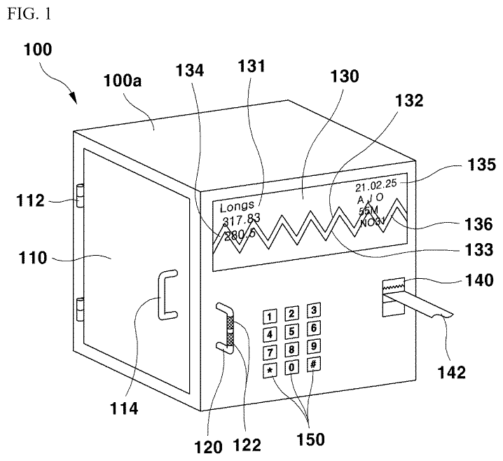

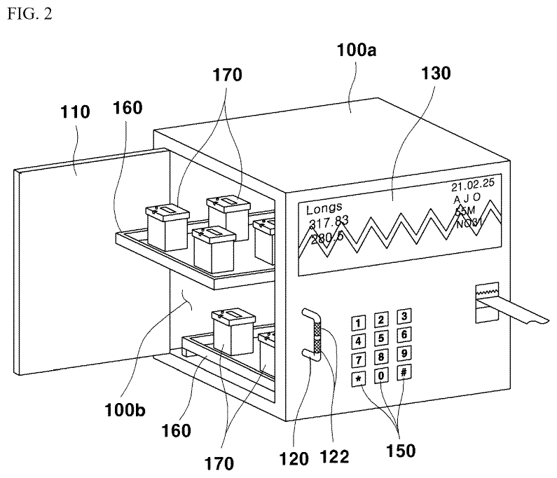

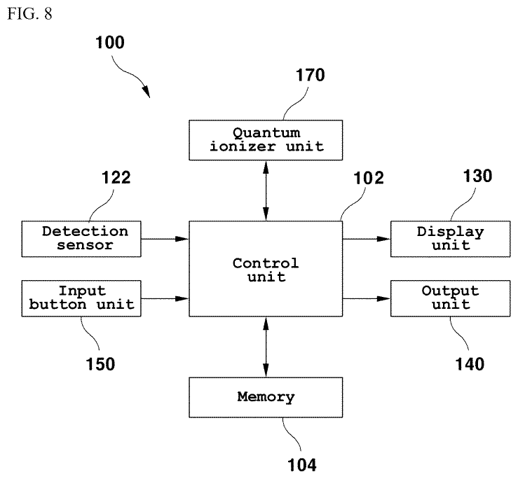

FIG. 1 is a perspective view showing a device for preparing quantum nanocomponent ionic water according to one embodiment of the present invention, FIG. 2 is a perspective view showing a device for preparing quantum nanocomponent ionic water of FIG. 1 in an open state, and FIG. 8 is a block view showing a configuration of a device for preparing quantum nanocomponent ionic water shown in FIG. 1.

As shown in the drawings, the device for preparing quantum nanocomponent ionic water 100 according to one embodiment of the present invention may be configured such that one side of a main body 100a having, for example, a hexahedral shape is opened and sealed by a door 110 coupled to the opened one side by a hinge 112, and a handle 114 is formed at the door 110.

An accommodation space 100b may be formed inside the main body 100a, and a shelf support may be formed in multiple stages as necessary on both inner walls of the main body 100a in which the accommodation space 100b is formed, thereby supporting the sliding-inserted shelf 160.

A quantum nanocomponent ionizer unit 170 may be seated in multiple stages as necessary on the shelf 160 and may be inserted into the main body, and in this case, a cable may be connected to the quantum nanocomponent ionizer unit 170 to receive power or receive power and information.

Preferably, one or more quantum nanocomponent ionizer units 170 may be provided as needed, and in this case, each quantum nanocomponent ionizer unit 170 may be connected to a cable to be individually supplied with power or to be supplied with power and information.

For example, an output unit 140, a display unit 130, a sensing unit 120, and an input button unit 150 may be provided outside the main body.

The sensing unit 120 may be configured such that, for example, (+) and (−) detection sensors 122 containing, for example, 92% of silver (Ag) are formed to be vertically spaced apart from each other in a vertical portion of a main body made of a plastic material having a handle shape of a door, that is, a “E” shape.

When the detection sensor 122 of the sensing unit 120 comes in contact with a palm for about one minute, the frequency of an area of the human body may be sensed and transmitted to a control unit 102, and the frequency may be stored in a memory 104.

The input button unit 150 may include, for example, a plurality of number (character) buttons and ON and OFF buttons.

For example, a resident registration number, a passport number, or an English initial may be entered and recorded through the plurality of number (character) buttons.

The display unit 130 may be configured such that, under the control of the control unit 102, an abnormal part 131 of the subject to be measured and normal and current measured frequencies (numbers) 134, which are detected through the detection sensor, are displayed at a left side of a screen, a measurement date, a subject to be measured 135, and an unique ID (for example, number) of the quantum nanocomponent ionizer unit 136 are displayed at a right side of the screen, and the measured frequency 132 of the most vulnerable part and the frequency 133 of the current part of the subject to be measured are displayed in a graph form throughout the screen.

The output unit 140 may be configured to output, under the control of the control unit 102, for example, a measurement date, a subject to be measured, and a unique ID (e.g., a number, a barcode, and a QR code) of the quantum nanocomponent ionizer unit as a printed matter 142.

As shown in FIG. 8, the device for preparing quantum nanocomponent ionic water 100 may include a control unit 102, a memory 104, a detection sensor 122, an input button unit 150, a display unit 130, an output unit 140, and a plurality of quantum nanocomponent ionizer units 170

First, if a hand comes in contact with the detection sensor 122 and a wave (frequency) of each area of the body (e.g., stomach, kidney, and lung) is measured for about one minute and output to the control unit 102, while DC 12 to 48 V power is supplied to the device for preparing quantum nanocomponent ionic water 100 and the resident registration number, passport number, telephone number, etc., of the subject to be measured are input through the input button unit 150, it may be printed in the output unit 140 and displayed on a screen of the display unit 130 under the control of the control unit 120, while being stored in the memory 104.

In addition, the control unit 102 may compare the measured frequency with a standard (intrinsic) frequency for each area stored in the memory 104, determine that the corresponding area has a disease when the frequency is decreased, transfer each wave (frequency) suitable for the corresponding area having the disease to distilled water in the quantum nanocomponent ionizer unit 170 through an oscillating body, sound waves, and diode lights of a plurality of the quantum nanocomponent ionizer unit 170 for 60 to 240 minutes, and make ionic water containing gold, silver, platinum, organic germanium, and water-soluble silicon at a concentration of 3 to 8 ppm in distilled water, thereby making, for example, 200 to 3,000 cc of the ionic water.

Then, when distilled water is continuously added, the wave may be transmitted to the quantum nanocomponent ionizer unit 170 according to the same information as stored in the memory 104, and ionic water containing an independent corresponding frequency component at a concentration of 3 to 8 ppm may be made for each quantum nanocomponent ionizer unit 170.

Accordingly, drinking ionic water containing gold, silver, platinum, organic germanium, and water-soluble silicon, which is made at a frequency suitable for the corresponding diseased area of the body, may lead to intensive cell regeneration, immunity enhancement, and sterilization at the corresponding area, thereby improving disease treatment and ameliorating various diseases.

Meanwhile, each quantum nanocomponent ionizer unit 170 may be configured to include a separate memory as necessary, and at this time, when distilled water and power are continuously input according to conditions even in a state of being separated from the main body 100a of the device for preparing quantum nanocomponent ionic water 100, the quantum nanocomponent ionizer unit 170 may transmit waves according to information previously input once and stored in the memory, and prepare ionic water containing gold, silver, platinum, germanium, and silicon with an independent corresponding frequency and at a concentration of 3 to 8 ppm.

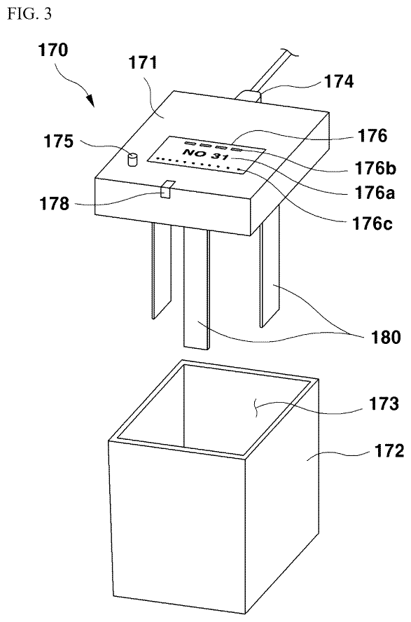

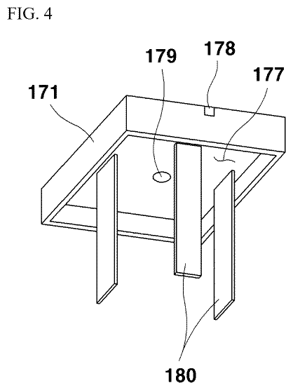

FIG. 3 is an exploded view showing a quantum nanocomponent ionizer unit shown in FIG. 1 according to one embodiment, and FIG. 4 is a perspective view showing a bottom surface of a vibration transfer cover shown in FIG. 3.

As shown in FIG. 3, the quantum nanocomponent ionizer unit 170 may be formed by coupling an upper vibration transfer cover 171 to a lower container filled with distilled water.

The lower container 172 may be made of glass or a plastic material and formed with an accommodation part 173 having an open top, and distilled water containing, for example, at least one of organic germanium and water-soluble silicon in an amount of 0.1 to 0.3% (volume) may be injected and filled into the accommodation part 173.

The vibration transfer cover 171 may include a display unit 176 for displaying a number for quantum nanocomponent ionizer units and subjects to be measured 176a, a remaining time 176b, and the number of uses 176c, and a switch 175 for individually operating the quantum nanocomponent ionizer unit, and an operation lamp 178 for indicating whether the quantum nanocomponent ionizer unit is operated may be provided at a surface, and a cable 174 may be connected to supply power or supply power and information.

If necessary, the quantum nanocomponent ionizer unit may be configured to further include a separate information storage memory.

Meanwhile, as shown in FIG. 4, an ionization vibration transfer member 180 consisting of a stick or rod made of a gold, silver, or platinum material may be mounted on a lower portion of the vibration transfer cover 171, and thus a part thereof may be immersed in distilled water filled in the lower container.

Distilled water may be made into ionic water containing gold, silver, organic germanium, platinum, and water-soluble silicon at a concentration of 3 to 8 ppm in distilled water by transmitting a wave suitable for a corresponding area of the body to the ionization vibration transfer member 180.

In other words, a wave transfer material may be at least one of gold, silver, platinum, organic germanium, and water-soluble silicon, and the ionization vibration transfer member 180 made of a gold, silver, or platinum material may be used exclusively for ionization or used for both an ionization+oscillating body.

Meanwhile, in ionic water containing gold, silver, platinum, organic germanium, and water-soluble silicon at a concentration of 3 to 8 ppm in distilled water, if the concentration is less than 3 ppm, the effect of ionic water may be deteriorated, and if the concentration is more than 8 ppm, the ions of gold, silver, and platinum may be aggregated in the process of preparing ionic water, and the effect of ionic water may be deteriorated.

In the meantime, an LED light transfer unit 179 may be provided at a lower portion of the vibration transfer cover 171 to transfer a wave to the distilled water or transfer a wave to the distilled water through a sound wave, thereby preparing ionic water.

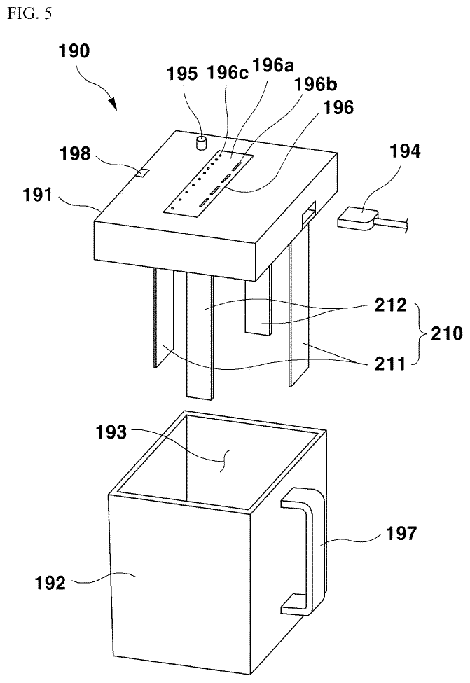

FIG. 5 is an exploded view showing a quantum nanocomponent ionizer unit shown in FIG. 1 according to another embodiment.

As shown in FIG. 5, according to another embodiment of the present invention, the quantum nanocomponent ionizer unit 190 may be formed by coupling an upper vibration transfer cover 191 to a lower container 192.

The lower container 192 may be formed with a handle, made of glass or a plastic material and provided with an accommodation part 193 having an open top, and distilled water containing, for example, at least one of organic germanium and water-soluble silicon in an amount of 0.1 to 0.3% (volume) may be injected and filled into the accommodation part 193 and a handle 197 may be formed at a side thereof.

The vibration transfer cover 191 may include a display unit 196 for displaying a number for quantum nanocomponent ionizer units and subjects to be measured 196a, a remaining time 196b, and the number of uses 196c, and a switch 195 for individually operating the quantum nanocomponent ionizer unit, and an operation lamp 198 for indicating whether the quantum nanocomponent ionizer unit is operated may be provided at a surface, and a cable 194 may be connected to supply power or supply power and information.

In addition, an ionization vibration transfer member 210 consisting of sticks 211 and 212 made of a gold or silver material may be mounted at a lower portion of the vibration transfer cover, and thus a part thereof may be immersed in distilled water filled in the lower container 192.

Distilled water may be made into ionic water containing gold, silver, organic germanium, and water-soluble silicon at a concentration of 3 to 8 ppm in distilled water by transmitting a wave suitable for a corresponding area of the body to the ionization vibration transfer member 210.

When the quantum nanocomponent ionizer units 170 and 190 shown in FIGS. 3 and 5 are provided in the device for preparing quantum nanocomponent ionic water 100, it may allow a wave selected from the main body to be transmitted to an oscillating body, sound waves and diode lights in a process of receiving power and wave information from the device for preparing quantum nanocomponent ionic water 100, adding distilled water and organic germanium and water-soluble silicon in the distilled water in an amount of 0.1 to 0.3% into a container, and having the ionization vibration transfer members 180 and 210 mounted in the quantum nanocomponent ionizer units 170 and 190 at a concentration of 3 to 8 ppm for 60 to 240 minutes.

In addition, when separating from the main body, it may be possible to generate the ionic water for several times as the wave per se indicated by the main body only by adding a separate power and distilled water.

In other words, a separate memory may be included to generate ionic water with an independent corresponding frequency component according to the stored information.

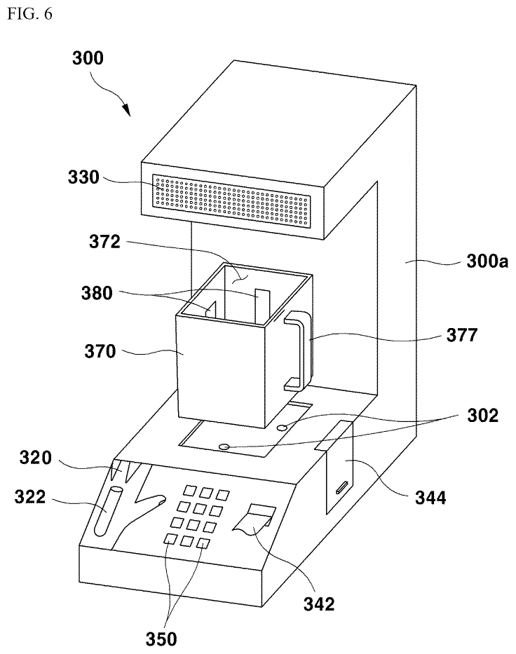

FIG. 6 is a perspective view showing a device for preparing quantum nanocomponent ionic water according to another embodiment of the present invention.

As shown in the drawings, according to another embodiment of the present invention, a main body 300a of a device for preparing quantum nanocomponent ionic water 300 may have a “⊐” shape in which vertical parts are integrally formed at upper and lower horizontal parts and a front and both sides thereof are open.

A display unit 330 may be provided at a front surface of the upper horizontal portion, in such a way that an abnormal part of the subject to be measured, normal and current measured frequencies (numbers), a measurement date, the subject to be measured, and an unique ID (for example, number) of the quantum nanocomponent ionizer unit, a frequency of the most vulnerable part during detection, and a frequency of the current part of the subject to be measured are displayed in a graph form.

An output unit 344, a sensing unit 320, and an input button unit 350 may be provided at a lower horizontal portion.

A detection sensor 322 of the sensing unit 320 may be formed in the sensing unit 320 which is formed to come in contact with a palm at a front surface of the lower horizontal portion, may detect a frequency of an area of the human body and transmit the detected frequency to the control unit when the palm comes in contact with the sensing unit 320, and then the detected frequency may be stored in the memory.

The input button unit 350 may include, for example, a plurality of number (character) buttons and ON and OFF buttons.

For example, a resident registration number, a passport number, an English initial, etc., may be entered and recorded through the plurality of number (character) buttons.

The output unit 344 may be configured to output, for example, a measurement date, a subject to be measured, and a unique ID (e.g., a number, a barcode, and a QR code) of the quantum nanocomponent ionizer unit as a printed matter 342 under the control of the control unit.

In addition, the quantum nanocomponent ionizer unit 370 may be located at an upper surface of the lower horizontal portion.

The quantum nanocomponent ionizer unit 370 may be made of glass or a plastic material and formed with an accommodation part 372 having an open top, and distilled water containing, for example, at least one of organic germanium and water-soluble silicon in an amount of 0.1 to 0.3% (volume) may be injected and filled into the accommodation part 372.

An ionization vibration transfer member 380 consisting of a stick or rod made of a gold, silver, or platinum material may be mounted on an upper portion of the container in which the accommodation part is formed and the ionization vibration transfer member 380 may be electrically connected to a power terminal 302 provided at an upper surface of a lower horizontal portion of the main body 300a.

A wave suitable for a corresponding area of the body may be transmitted to the ionization vibration transfer member 380, and then distilled water may be made into ionic water containing gold, silver, platinum, organic germanium, and water-soluble silicon at a concentration of 3 to 8 ppm in distilled water.

In addition, a handle 377 may be formed at one side of the container 370.

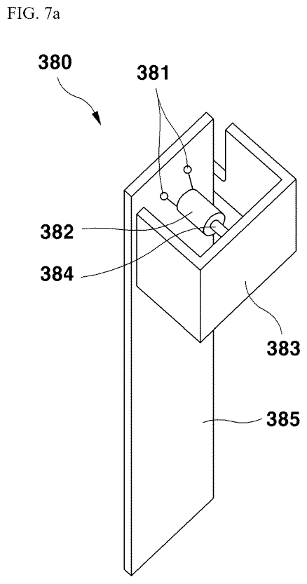

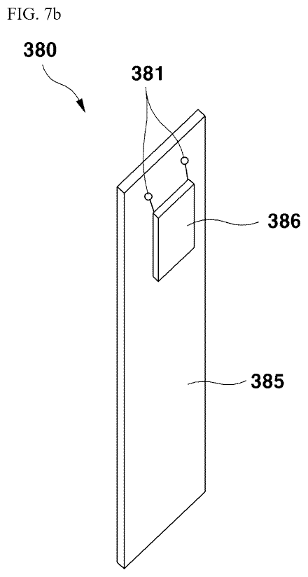

FIGS. 7A and 7B are perspective views showing an ionization vibration transfer member applied to a device for preparing quantum nanocomponent ionic water of the present invention.

As shown in FIG. 7a, the ionization vibration transfer members 180, 210 and 380 (hereinafter, 380) may have a thin plate shape, in which a coil 382 is formed in the middle of one surface of the oscillating body 385 made of a gold, silver, platinum, organic germanium, or water-soluble silicon material and connected to a power supply terminal 381, and permanent magnet 384 inserted into the coil is formed at an opposite side of the coil 382, and thus supported by a magnet support 383 fixedly attached to one surface of the oscillating body 385.

In this configuration, when power is supplied to the power terminal 381, electricity may flow in the coil 382 to make an electromagnet, which may be linked with a magnetic force of the permanent magnet, and the vibration may be transmitted to distilled water through the oscillating body 385.

As shown in FIG. 7b, the ionization vibration transfer members 180, 210 and 380 (hereinafter, 380) may have a thin plate shape, and piezoelectric ceramic 386 may be attached to one surface of the oscillating body 385 made of a gold, silver, platinum, organic germanium, or water-soluble silicon material and connected to a power supply terminal 381.

In this configuration, when power is supplied to the power terminal 381, power may be supplied to the piezoelectric ceramic 386 to vibrate, and the vibration may be transmitted to distilled water filled in the container through the oscillating body 385.

In the above, the technical idea of the present invention has been described with the accompanying drawings, but this is an exemplary description of a preferred embodiment of the present invention, but does not limit the present invention.

In addition, it is obvious that any person skilled in the art in the technical field to which the present invention pertains can modify and imitate various modifications without departing from the scope of the technical idea of the present invention.

What is claimed is:

1. A device for preparing quantum nanocomponent ionic water, the device comprising: a quantum nanocomponent ionizer unit for generating ionic water by transmitting, to distilled water put into a container, in wave form, at least one from among an oscillating body, sound waves, and diode lights; a sensing unit having a detection sensor in contact with a palm so as to measure wave (frequency) in an area of a body of a subject to be measured; and a control unit which compares the measured frequency of the detection sensor with a standard frequency in each area so as to determine a diseased area, and which instructs the quantum nanocomponent ionizer unit to provide each wave suitable for the diseased area.

2. The device of claim 1, wherein the quantum nanocomponent ionizer unit is formed by coupling an upper vibration transfer cover to a lower container filled with distilled water, in which the lower container is made of glass or a plastic material and formed with an accommodation part filled with distilled water containing organic germanium and a water-soluble silicon component, and an ionization vibration transfer member made of a gold, silver, or platinum material is mounted on a lower portion of the vibration transfer cover and thus immersed in distilled water filled in the lower container.

3. The device of claim 2, wherein the vibration transfer cover includes a display unit for displaying a number for quantum nanocomponent ionizer units and subjects to be measured, a remaining time, and a number of uses, a switch for individually operating the quantum nanocomponent ionizer unit, and an operation lamp for indicating whether the quantum nanocomponent ionizer unit is operated, and is connected to a cable to provide power or to provide power and information.

4. The device of claim 3, wherein an accommodation space is formed inside a main body of the device for preparing quantum nanocomponent ionic water, and a shelf support is formed in multiple stages on opposite inner walls of a main body in which the accommodation space is formed, so that a shelf on which a plurality of quantum nanocomponent ionizer units are seated is supported.

5. The device of claim 2, wherein the device for preparing quantum nanocomponent ionic water further includes: an input button unit consisting of a plurality of number or character buttons and ON and OFF buttons; a display unit for displaying, under a control of the control unit, an abnormal part of the subject to be measured, and normal and current measured frequencies (numbers), which are detected through a detection sensor, a measurement date, a subject to be measured, and an unique ID of the quantum nanocomponent ionizer unit, and displaying a measured frequency of a most vulnerable part and a frequency of a current part of the subject to be measured in a graph form; and an output unit for outputting, under the control of the control unit, a measurement date, a subject to be measured, and a unique ID of the quantum nanocomponent ionizer unit as a printed material.

6. The device of claim 2, wherein the ionization vibration transfer member is configured such that a coil is formed at one surface of an oscillating body made of a gold, silver, or platinum material in a thin plate-shape, and a permanent magnet inserted into the coil is formed at an opposite side of the coil and supported by a magnet support, which is fixedly attached to one surface of the oscillating body.

7. The device of claim 2, wherein the ionization vibration transfer member is formed by attaching piezoelectric ceramic to one surface of an oscillating body made of a gold, silver, or platinum material in a thin plate shape.

8. The device of claim 1, wherein the sensing unit is configured such that (+) and (−) detection sensors containing silver (Ag) are vertically spaced apart from each other in a vertical portion of the main body made of a plastic material having a “E” shape.

9. The device of claim 1, wherein the quantum nanocomponent ionizer unit includes a container in which distilled water is filled into an accommodation part having an open top, in which an ionization vibration transfer member made of a gold, silver, or platinum material is mounted on an upper portion of the container and thus immersed in the distilled water filled in the container, and the ionization vibration transfer member is electrically connected to a power supply terminal provided at an upper surface of a lower horizontal portion of the main body.
